(19) United States
(12) Patent Application Publication
(10) Pub. No.: US 2007/0049274 A1
(43) Pub. Date: Mar. 1, 2007

(54) Hard handoff from a wireless local area network to a cellular telephone network

(76) Inventors: Eitan Yacobi, Zichron-Ya'skov (IL); Ron Keidar, Haifa (IL); Samer Zreiq, Haifa (IL); Yoram Rimoni, Haifa (IL)

Correspondence Address: QUALCOMM INCORPORATED, 5775 MOREHOUSE DR., SAN DIEGO, CA, 92121, US

(21) Appl. No.: 11/219,064

(22) Filed: Sep. 1, 2005

(51) Int. Cl. H04Q 7/20

(52) U.S. Cl. 455/436

(57) ABSTRACT

A system and a method are provided for supporting a hard handoff procedure for a call from a wireless local area network (WLAN) to a cellular telephone network. The method includes: establishing a link between a user terminal (UT) and a serving WLAN, and a call via the WLAN link; simultaneously monitoring a serving cellular telephone network; forwarding information identifying the UT within the cellular network, to the serving WLAN; in response to losing the link with the serving WLAN, performing a hard handoff to the cellular network; and, continuing the call via the cellular network. Generally, the hard handoff can be performed if the WLAN is able to communicate the UT's identity to the cellular telephone, as the UT's position can be determined by the cellular network. The hard handoff is performed with the UT receiving resource allocations in a common control channel message, such as a Short Message Ser vice (SMS) or paging message.

### BACKGROUND OF THE INVENTION

1. Field of the Invention

This invention generally relates to wireless communications and, more particularly, to a system and method for a hard handoff from a wireless local area network (WLAN) to a cellular telephone network.

2. Description of the Related Art

WLANs compliant with IEEE 802.11, Bluetooth, and networks generally compliant with IEEE 802.15, such as wireless personal area network (WPANs) and ultra-wideband (UWB) networks, all share the characteristics of being relatively low power networks with high data rates. Bluetooth and 802.15 networks are envisioned for use in a “personal space”, such as an office, room, or car, while 802.11 networks operate at larger power levels and are intended to cover larger geographical areas.

All the above-mentioned networks can be enabled to support wireless communications services conventionally associated with cellular telephones, such as voice calls and data streaming. However, while cellular telephone links are relatively robust, WLAN links are more susceptible to interruption. When a cellular user terminal (UT) reaches the boundary of a cell site, there is usually enough time to handoff an in-progress call to an adjoining cell. Handoff procedures between WLAN hotspots or access points (APs) are not as well established as they are for cellular networks. WLAN networks are designed for packet data communications, as opposed to real-time voice communications. The delays associated with reacquiring a hotspot are not as noticeable when data is being communicated.

In addition, WLAN coverage planning is often incomplete or sporadic. Further, the small geographical area associated with a hotspot means that a UT can move from a strong link, to loss of coverage almost instantaneously. The end result is that calls being carried by a WLAN link are susceptible to being dropped before any kind of handoff can be engaged to another access point or network.

It would be advantageous if a hard handoff procedure existed, to transfer a call being carried by a WLAN link, to a cellular telephone network, in the event that the WLAN network link is lost.

### SUMMARY OF THE INVENTION

Accordingly, a hard handoff system and a method are provided for supporting a hard handoff procedure for a call from a WLAN to a cellular telephone network. The method comprises: establishing a link between a UT and a serving WLAN and establishing a call via the WLAN link; simultaneously monitoring a serving cellular telephone network; forwarding information identifying the UT within the cellular network, to the serving WLAN; in response to losing the link with the serving WLAN, performing a hard handoff to the cellular network; and, continuing the call via the cellular network.

Generally, the hard handoff can be performed if the WLAN is able to communicate the UT's cellular network identity, as the UT's position in the cellular network is known. For example, monitoring a serving cellular network may entail monitoring a serving Base Station Transceiver (BTS) in the cellular network. This step entails the cellular network tracking the UT's position, as a consequence of control channel communications between the UT and a network cell or registration zone. The step of forwarding information identifying the UT within the cellular network may include forwarding information such as the ESN, MEID, IMSI, or MIN associated with the UT, depending upon the type of cellular network in which the UT is registered.

More specifically, the hard handoff to the cellular network is performed with the UT receiving cellular network resource allocations in a common control channel message, such as a Short Message Service (SMS) or paging message. Then, the UT tunes to an allocated channel in the cellular network, in response to the common control channel message.

Additional details of the above-described method, and a multi-mode portable UT with a hard handoff capability for transferring a call from a WLAN to a cellular telephone network, are provided below.

### BRIEF DESCRIPTION OF THE DRAWINGS

FIG. 1 is a schematic block diagram of a system that supports a hard handoff procedure for transferring a call from a wireless local area network (WLAN) to a cellular network user terminal (UT).

FIG. 2 is a schematic block diagram depicting a UT operating in both a 802.11 hotspot and a cellular network.

FIG. 3 depicts a WLAN to CDMA UHDM-like message flow diagram.

FIG. 4 is a flowchart illustrating a method for supporting a hard handoff procedure for a call from a WLAN to a cellular telephone network in a multi-mode portable UT.

### DETAILED DESCRIPTION

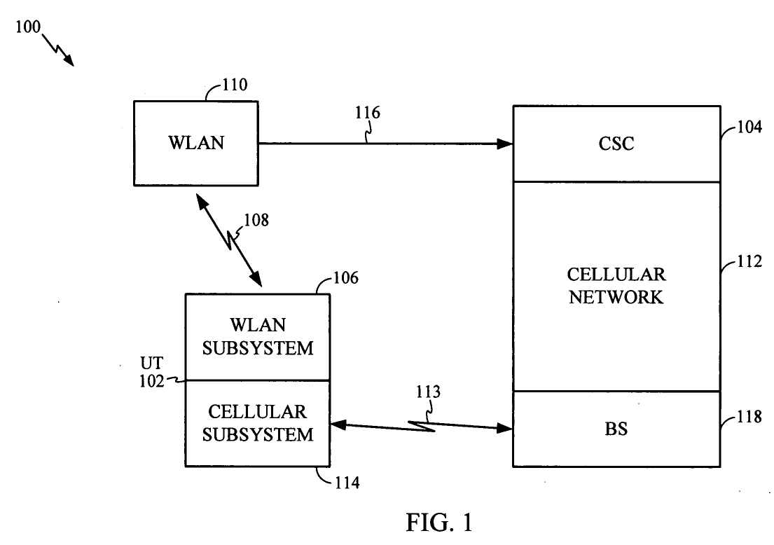

FIG. 1 is a schematic block diagram of a system that supports a hard handoff procedure for transferring a call from a wireless local area network (WLAN) to a cellular network. The system 100 comprises a user terminal (UT) 102 and a cellular server controller (CSC) 104. The UT 102 comprises a WLAN subsystem 106 to establish call through a (wireless) link 108 between the UT 102 and a serving WLAN 110. For example, the UT may be a wireless cellular telephone that also has the capability of communicating with a WLAN. As user herein, WLAN typically describes an IEEE 802.11, IEEE 802.15, or Bluetooth network. However, the system is not limited to any particular network type. Generally, the UT WLAN subsystem 106 forwards information, to the serving WLAN 110, which identifies the UT 102 within a cellular network 112. The WLAN 110 uses this information to identify the UT 102 as a registered unit in the cellular telephone network 112.

The UT 102 also comprises a cellular subsystem 114 registered in, and monitoring the serving cellular telephone network 112 via wireless link 113. In the event of the call being dropped (the link being lost) by the WLAN 110, the cellular subsystem 114 receives a hard handoff command to continue the call via the cellular network 112.

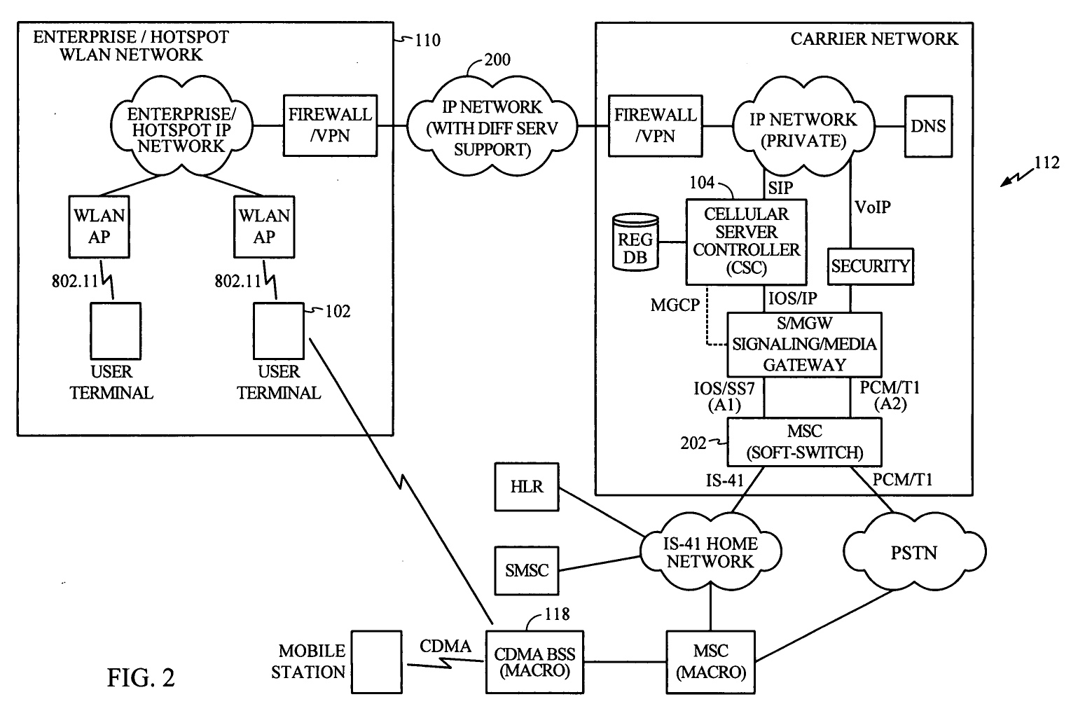

The CSC 104 has an interface on line 116 with the WLAN 110 to receive a hard handoff request for an identified UT 102. The UT's position in the cellular network is information that is conventionally tracked by an MSC/VLR (not shown) in accordance with standard network policies. Because the CSC has acquired the UT identity, and the UT's position in the cellular network is known, the CSC 104 is able to further the initiation of a hard handoff command to the UT cellular subsystem 114 in response to the hard handoff trigger. Additional details of the WLAN and cellular networks are provided in the explanation of FIG. 2 below.

As noted above, the UT 102 is a multi-mode portable device supporting a hard handoff procedure for a call from a WLAN to a cellular telephone network. The WLAN subsystem 106 establishes a link 108 between the UT and the serving WLAN 110, and establishes a call via the established WLAN link 108. The link 108 is also used to forward information identifying the UT within the cellular network 112, to the serving WLAN 110. For example, the WLAN can be an IEEE 808.11, Bluetooth, or IEEE 802.15 network, and the WLAN call can be in a format such as packet data, voice over Internet Protocol (VoIP), or video telephony (VT). However, the UT is not necessarily limited to any particular WLAN call format or network type.

The information that the WLAN subsystem 106 forwards to identify the UT within the cellular network is typically the UT's cellular network identity. Depending upon the cellular network type, the UT identity information may be the UT ESN, MEID, IMSI, or MIN associated with the UT. Electronic Serial Number (ESN) is a number used to identify a particular device or piece of hardware. Mobile Equipment ID (MEID) is likewise a device identifier. International Mobile Subscriber Identity (IMSI) is a number used to identifier a subscriber (phone number) in a cellular network. Mobile Identity Number (MIN) is the 10-digit number previously used in North American networks, which has since been replaced by IMSI. Other types of identifiers can potentially be used, as long as they are known by both the UT and the cellular network.

Generally, the UT 102 can be said to monitor the serving cellular network. When the UT first acquires the cellular network, it must perform a registration procedure. In this procedure the UT provides the network with its current location (cell ID). When the UT 102 moves within the cellular network, it may change the cell it listens to (monitors) based upon reception quality. The UT provides location information back to the cellular network based on network policies. This can be done on time basis or registration zone basis, for example, although other procedures are known. When the network needs to reach (page) the UT, it attempts the last known (reported) cell or registration zone. Alternately, a flooding page may be used. So, the network has its own capabilities to reach the UT. Typically, the footprint of the cellular network cell is larger than the WLAN hotspot. Hence, the UT is much more likely to change hotspots, or lose a WLAN link, than it is to change cellular network cells.

After initially registering with the cellular network 112 in a conventional manner, the UT cellular subsystem monitors a serving cell or Base Station Transceiver (BTS), or a group of cells (a registration zone) associated with a Base Station Controller (BSC) in the cellular network. This monitoring function is intended to describe the conventional pattern of control channel communications that occur between a UT and cellular network while the UT is registered, but not actively engaged in a cellular network call.

In addition to these conventional reporting procedures, the system may be enabled so that the UT sends periodic reports, concerning its reception of the surroundings cellular system, to the CSC via both the WLAN and the cellular system. For example, each report may include the measurements of the four strongest cellular cells being received by the UT. The CSC updates the record of the UT's position using these reports. In the event that a WLAN link is lost during a call, the CSC can promote the hard handoff based upon knowledge obtained from updates received via both the WLAN and cellular network. In yet another aspect, the CSC primarily depends up position reports received via the WLAN network to update the location of the UT in the cellular network.

The present invention system and UT are applicable to any kind of cellular network. For example, the cellular network may be a Code Division Multiple Access (CDMA), Global System for Mobile Communications (GSM), or Universal Mobile Telecommunications System (UMTS) networks. However, the invention is not limited to just these cellular networks.

The UT cellular subsystem 114 receives a hard handoff command from the cellular network 112, in response to the UT WLAN subsystem 106 losing the link 108 with the serving WLAN 110. After receiving the hard handoff command, the cellular subsystem 114 continues the call via the cellular network 112.

More specifically, the UT cellular subsystem 114 receives a hard handoff command, with cellular network resource allocations in a common control channel message, such as a paging message, SMS message, or a multicast SMS message. However, it is possible to communicate resource allocations in other types of control messages. In response to the control channel message, the cellular subsystem 114 tunes to an allocated traffic channel within the cellular network. After establishing a traffic channel connection with a serving BTS (not shown) associated with BS 118, the cellular subsystem 114 sends a Handoff Completion Message (HOCM) to that serving BTS.

FIG. 2 is a schematic block diagram depicting a UT operating in both a 802.11 hotspot and a cellular network. The cellular network 112 comprises a network entity, referred to herein as CSC 104, which tracks the UT 102, even as the UT is engaged in a call carried over a WLAN link. The UT 102 monitors the cellular network 112, and the cell (BTS) that is best able to communicate with the UT. The UT may be a dual mode device, with two radio frequency (RF) transceivers that are able to monitor and link to the WLAN and cellular networks simultaneously. Alternately, the UT may be a single mode device that monitors one network (i.e., the cellular network) while you are temporary disabling the link with the serving network (i.e. the WLAN). This procedure is already defined for a UT operating in an IS-95 or IS-2000 cellular network.

When a radio link loss is detected by the hotspot network, a request is sent to the cellular network, via Internet Protocol (IP) network 200, to the cellular network 112. Specifically, a request is sent that a traffic channel be built between the UT 102 and the currently monitored BTS associated with BS 118 that has been tracked by the mobile services switching center (MSC) 202. The CSC 104 directs that the resources allocated to the UT, and also directs that the allocations be communicated to the UT via a paging or other control channel.

As shown, the CSC 104 is an entity distinct from the MSC 202. In one aspect, the CSC 104 is configured to operate like a Short Message Service Center (SMSC). In this manner, the resource allocation information can be sent to the UT in the form of a SMS message. In this aspect the UT has an address to which the SMS message can be sent that is always registered, known to all terminals, and is never engaged in a call. The SMS message can be formatted like a paging message, carrying an array of one or more structures that include the UT ID, along with resource allocations. Once the UT receives this SMS handoff notification, it can begin conventional handoff procedures, as if the call was being transferred between BTS units in the cellular network.

In the event that the cellular network is limited to sending SMS messages to large registration areas. The system may be optimized to associate the UT with the best BTS by assigning a different UT address to every registration zone. A registration zone is understood to be a cellular network region that can be a BTS or group of BTS units associated with a particular BSC. The UT and the CSC know a priori the unique address associated with each registration zone. This can be accomplished by having the UT report its current registration zone in its monitoring reports to the CSC. In some aspects, the UT can send an update to the cellular network when it changes its service cell in the cellular network, while being served by a WLAN. In another aspect, the UT sends a location update message to the cellular network when a call is initiated in the WLAN. In the event that the UT loses its WLAN link during a call, these options permit the network track the UT location to a single known cell. Thus, enabling a rapid handoff in the event the WLAN link is lost.

For example, a hash algorithm can be used to generate a phony address for each registration zone. The Visiting Location Register (VLR) database would include information cross-referencing UT addresses with particular registration zones. Conventionally, a VLR maintains temporary user information, such as current location, to manage requests from subscribers who are out of the area covered by their home system.

The VLR collects and sends routing information to the MSC, which permits the MSC to connect to the UT.

Alternately, the CSC may send a handoff notification, which is also referred to herein as a Universal Handoff Direction Message (UHDM)-like message, to the UT in a broadcast/multicast SMS mechanism to relevant registration zones. This aspect may require enhancements to the IS-41 standard that are not currently supported. Although the example system of FIG. 2 specifically depicts an 802.11 WLAN and a CDMA wireless network, it should be understood that the invention can be practiced in a similar manner between other types of WLANs and other types of cellular networks.

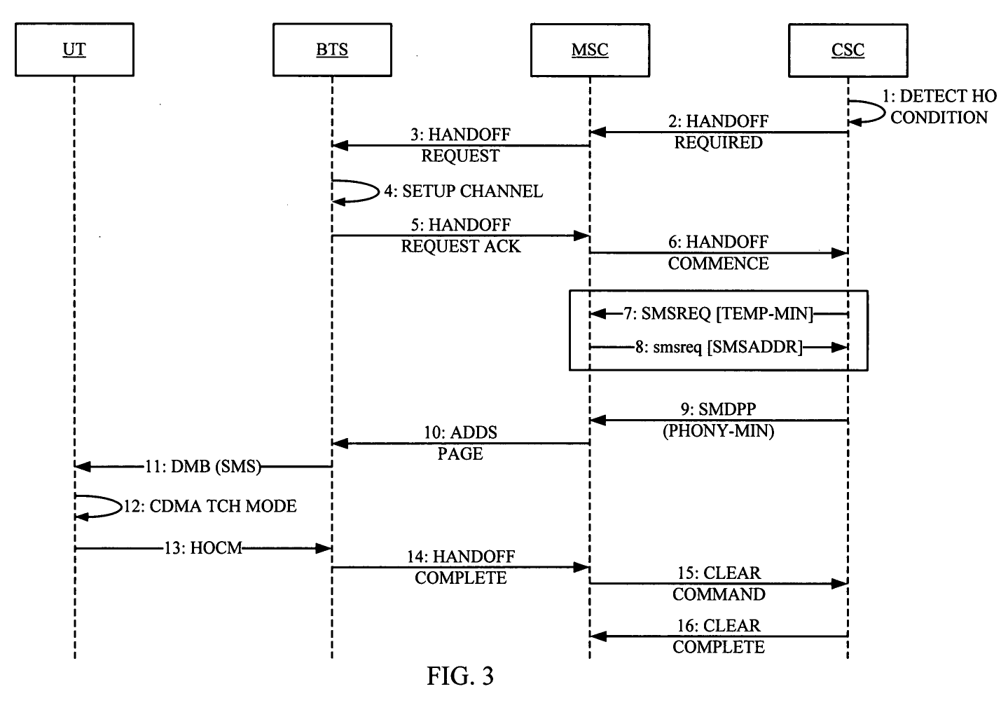

FIG. 3 depicts a WLAN to CDMA UHDM-like message flow diagram. In a conventional hard handoff procedure, the serving BS initiates a hard handoff to a target BS in response to a trigger. The serving BS waits until the resources are set up in the target cell, and then commands the UT by sending a UHDM to perform the handoff to the specified BS. With the above-described hotspot architecture, the serving WLAN network cannot send a UHDM message to the UT, since the handoff trigger only occurs after the link between the UT and WLAN has been lost. The diagram can be explained with the following sequence of steps.

Through communications with the WLAN, the CSC initially detects that the WLAN call link has been lost. This event triggers the CSC to start a handoff procedure from the WLAN network to the cellular network.

The CSC initiates an inter BSC hard handoff procedure by sending a Handoff Required IOS message to the MSC, giving the CELL_ID information forwarded to CSC from the UT, via the WLAN.

The MSC communicates with the target BS to initiate a handoff.

The target BS allocates and sets up traffic channels for use by the UT.

Once the traffic channels are set, the BS responds to the MSC with a Handoff Request Acknowledgement message.

The MSC forwards the handoff parameters to the CSC by sending an IOS Handoff Command message.

The CSC builds an UHDM-like message, packed inside a SMS message, and initiates a SMS transmission to a well-known phony MIN mobile (the UT) that is associated with the target BS. The CSC sends a SMSREQ message to the MSC.

The MSC responds with a smsreq message back to the CSC. Note, Steps 7 and 8 can be performed in parallel to the performance of Steps 1-6, to minimize latency.

The CSC sends the SMS with the UHDM-like message to the phony MIN number in an SMDPP message.

The MSC, upon receipt of the SMDPP message, builds an ADDS Page message and sends that to the target BS through which the phony MIN has been registered.

The BS sends a DBM message to the UT. The DBM includes the SMS with the UHDM-like message.

Once the UT receives the SMS message on the paging channel addressed to its well-known phony address, it jumps into the CDMA mode. The UT initializes its state to the cellular active state, and when it detects the F-FCH of the target BS, it sends the Handoff Completion Message (HOCM) to the BS.

The BS sends a Handoff Complete message to the MSC, indicating that the handoff has been successfully completed.

Once the MSC receives the Handoff Complete message, it sends a Clear Command to the CSC.

The CSC releases all resources associated with the call and responds to the MSC with a Clear Complete message.

Although the FIG. 3 specifically depicts an 802.11 WLAN and a CDMA wireless network message flow, it should be understood that the invention can be practiced in a similar manner between other types of WLANs and other types of cellular networks.

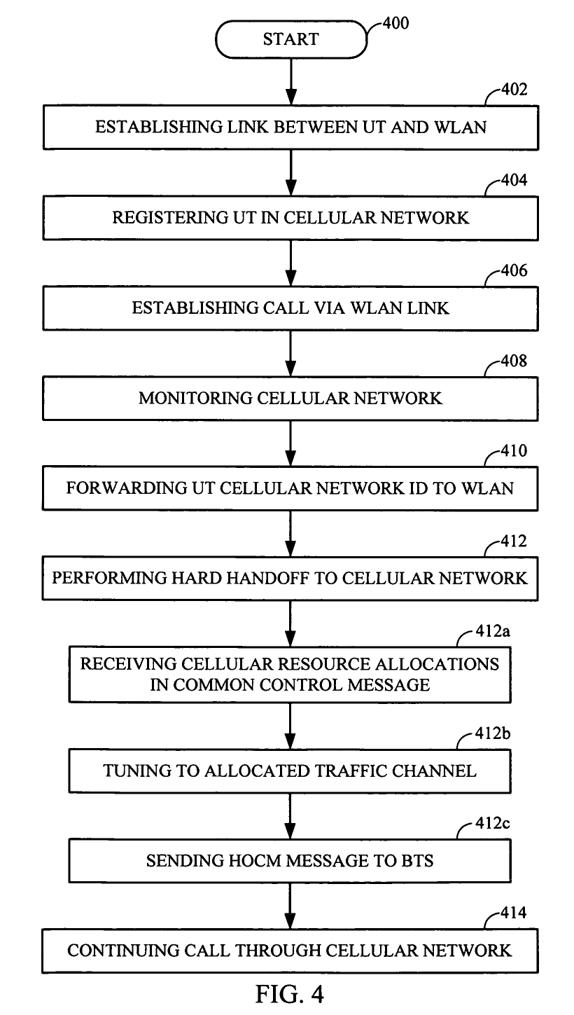

FIG. 4 is a flowchart illustrating a method for supporting a hard handoff procedure for a call from a WLAN to a cellular telephone network in a multi-mode portable UT. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 400.

Step 402 establishes a link between a UT and a serving WLAN. The WLAN can be an IEEE 802.11, IEEE 802.15, or Bluetooth network for example. Step 404 registers the UT in a cellular network, such as a CDMA, GSM, or UMTS network. Step 406 establishes a call via the established WLAN link. For example, the call can be in a packet data, voice over Internet Protocol (VoIP), or video telephony (VT) format. Simultaneously with Step 406, Step 408 monitors the serving cellular telephone network. For example, Step 408 may monitor a serving cellular network region such as a cell (BTS) or a group of cells (registration zone) associated with a BSC.

Step 410 forwards information identifying the UT within the cellular network, to the serving WLAN. For example, the information can be an ESN, MEID, IMSI, or MIN associated with the UT. Step 412 performs a hard handoff, from the WLAN network, to the cellular network in response to losing the link with the serving WLAN. Step 414 continues the call via the cellular network.

In one aspect, performing the hard handoff to the cellular network in Step 412 includes substeps. Step 412a receives cellular network resource allocations in a common control channel message, such as paging message, a SMS message, or a multicast SMS message. Step 412b tunes to an allocated traffic channel with the cellular network in response to the common control channel message. Step 412c sends a Handoff Completion Message (HOCM) to a serving BTS, in response to establishing a traffic channel connection with the serving BTS. Typically, Steps 402 through 414 must be completed within a time frame of about 50 to 150 milliseconds, or the call is lost.

A system and method have been provided for a hard handoff process that transfers a call from a WLAN to a cellular network. Examples have been provided to illustrate the invention, especially in the context of CDMA and 802.11 networks. However, the invention is not limited to merely these examples. Other variations and embodiments of the invention will occur to those skilled in the art.

We claim:

1. In a multi-mode portable user terminal (UT), a method for supporting a hard handoff procedure for a call from a wireless local area network (WLAN) to a cellular telephone network, the method comprising:
establishing a link between a UT and a serving WLAN;
establishing a call via the established WLAN link;
simultaneously monitoring a serving cellular telephone network;
forwarding information identifying the UT within the cellular network, to the serving WLAN;
in response to losing the link with the serving WLAN, performing a hard handoff to the cellular network; and
continuing the call via the cellular network.

2. The method of claim 1 wherein establishing the call between the UT and the serving WLAN includes establishing a call in a format selected from the group comprising packet data, voice over Internet Protocol (VoIP), and video telephony (VT).

3. The method of claim 1 wherein establishing the call between the UT and the serving WLAN includes establishing the call with a WLAN selected from the group comprising IEEE 808.11, Bluetooth, and IEEE 802.15 networks.

4. The method of claim 1 wherein performing the hard handoff to the cellular network includes handing the call to a cellular network selected from the group comprising Code Division Multiple Access (CDMA), Global System for Mobile Communications (GSM), and Universal Mobile Telecommunications System (UMTS).

5. The method of claim 1 wherein simultaneously monitoring a serving cellular network includes monitoring a serving Base Station Transceiver (BTS) in the cellular network; and
wherein forwarding information identifying the UT within the cellular network includes forwarding information selected from the group comprising a UT Electronic Serial Number (ESN), Mobile Equipment ID (MEID), International Mobile Subscriber Identity (IMSI), and Mobile Identity Number (MIN).

6. The method of claim 5 wherein monitoring the serving BSC in the cellular network includes locating the UT within a cellular network region selected from the group comprising a cell (BTS) and a registration zone (a group of cells).

7. The method of claim 1 wherein performing the hard handoff to the cellular network includes:
receiving cellular network resource allocations in a common control channel message; and
in response to the common control channel message, tuning to an allocated traffic channel with the cellular network.

8. The method of claim 7 wherein receiving cellular network resource allocations in the common control channel message includes receiving a common control channel message selected from the group comprising a paging message, a Short Message Service (SMS) message, and multicast SMS message.

9. The method of claim 7 wherein performing the hard handoff to the cellular network includes the UT sending a Handoff Completion Message (HOCM) to a serving BTS, in response to establishing a traffic channel connection with the serving BTS.

10. The method of claim 1 further comprising:
prior to monitoring the serving cellular network, registering the UT in the cellular network.

11. A multi-mode portable user terminal (UT) for supporting a hard handoff procedure for a call from a wireless local area network (WLAN) to a cellular telephone network, the UT comprising:
a WLAN subsystem for establishing a link between the UT and a serving WLAN, establishing a call via the established WLAN link, and forwarding information identifying the UT within the cellular network, to the serving WLAN; and
a cellular subsystem for monitoring a serving cellular telephone network, receiving a hard handoff command, in response to the WLAN subsystem losing the link with the serving WLAN, and continuing the call via the cellular network.

12. The UT of claim 11 wherein the WLAN subsystem establishes a call with the serving WLAN in a format selected from the group comprising packet data, voice over Internet Protocol (VoIP), and video telephony (VT).

13. The UT of claim 11 wherein the WLAN subsystem establishes the call with a WLAN selected from the group comprising IEEE 808.11, Bluetooth, and IEEE 802.15 networks.

14. The UT of claim 11 wherein the cellular subsystem monitors a cellular network selected from the group comprising Code Division Multiple Access (CDMA), Global System for Mobile Communications (GSM), and Universal Mobile Telecommunications System (UMTS).

15. The UT of claim 11 wherein the cellular subsystem monitors a serving Base Station Transceiver (BTS) in the cellular network; and
wherein the WLAN subsystem forwards information identifying the UT within the cellular network by forwarding information selected from the group comprising a UT Electronic Serial Number (ESN), Mobile Equipment ID (MEID), International Mobile Subscriber Identity (IMSI), and Mobile Identity Number (MIN).

16. The UT of claim 15 wherein the cellular subsystem provides UT location information within a cellular network region selected from the group comprising a cell and a registration zone (a group of cells).

17. The UT of claim 11 wherein the cellular subsystem receives a hard handoff command, with cellular network resource allocations in a common control channel message, and tunes to an allocated traffic channel with the cellular network.

18. The UT of claim 17 wherein the cellular subsystem receives cellular network resource allocations in the common control channel message selected from the group comprising a paging message, a Short Message Service (SMS) message, and multicast SMS message.

19. The UT of claim 17 wherein the cellular subsystem sends a Handoff Completion Message (HOCM) to a BTS, in response to establishing a traffic channel connection with the serving BTS.

20. The UT of claim 11 wherein the cellular subsystem registers with the cellular network, prior to monitoring the serving cellular network.

21. A system that supports a hard handoff procedure for transferring a call from a wireless local area network (WLAN) to a cellular network, the system comprising:
a user terminal (UT) comprising:
a WLAN subsystem to establish call through a link between the UT and a serving WLAN, and forward information identifying the UT within a cellular network, to the serving WLAN; and,
a cellular subsystem registered in, and monitoring the serving cellular telephone network, and receiving a hard handoff command to continue the call via the cellular network; and,
a cellular server controller (CSC) having an interface with the WLAN to accept a hard handoff trigger for an identified UT and to further a hard handoff command to the UT cellular subsystem in response to the hard handoff trigger.

22. At least one processor configured to implement a method for supporting a hard handoff procedure for a call from a wireless local area network (WLAN) to a cellular telephone network, the method comprising:
establishing a link between a UT and a serving WLAN;
establishing a call via the established WLAN link;
simultaneously monitoring a serving cellular telephone network;
forwarding information identifying the UT within the cellular network, to the serving WLAN;
in response to losing the link with the serving WLAN, performing a hard handoff to the cellular network; and
continuing the call via the cellular network.

23. A computer-readable medium embodying instructions, which when executed by a process implements a method for supporting a hard handoff procedure for a call from a wireless local area network (WLAN) to a cellular telephone network, the method comprising:
establishing a link between a UT and a serving WLAN;
establishing a call via the established WLAN link;
simultaneously monitoring a serving cellular telephone network;
forwarding information identifying the UT within the cellular network, to the serving WLAN;
in response to losing the link with the serving WLAN, performing a hard handoff to the cellular network; and
continuing the call via the cellular network.
